(19) United States
(12) Patent Application Publication
(10) Pub. No.: US 2008/0178948 A1
(43) Pub. Date: Jul. 31, 2008

(54) Safety Leaky Check Valve for Slow Bleed of Compressed Air

(76) Inventors: Max Wilmshurst, Coupeville, WA (US); Linda Holland, Coupeville, WA (US)

Correspondence Address: GEORGE S. LEVY, 3980 DEL MAR MEADOWS, SAN DIEGO, CA, 92130, US

(21) Appl. No.: 12/013,137

(22) Filed: Jan. 11, 2008

Related U.S. Application Data
(60) Provisional application No. 60/897,598, filed on Jan. 26, 2007.

(51) Int. Cl. F16K 17/00; F16K 15/04

(52) U.S. Cl. 137/513.5

(57) ABSTRACT

A leaky check valve for preventing sudden decompression while allowing the air to exit at a safe and slow rate. The valve comprises a hollow cylindrical connector typically equipped at either ends with a coupling means. This connector holds on the inside a) an annular valve seat in the shape of a truncated cone, oriented such that the truncated apex of the cone faces the inlet, and the inner surface of the cone faces the outlet. The inner surface of the valve seat is indented with at least one radial groove; b) a ball positioned within the cylindrical connector, between the annular seat and the outlet; and c) a ball restraint located between the ball and the outlet.

This invention claims the benefit of U.S. Provisional Application No. 60/897,598 entitled “Pneumatic Safety Plug” filed Jan. 26, 2007 and which is hereby incorporated by reference. Applicant claims priority pursuant to 35 U.S.C. Par 119(e)(i). The present invention relates to a safety check valve used with compressed air.

### FIELD OF THE INVENTION

### Background

Long hoses containing compressed air present a danger when they are suddenly disconnected from the compressed air source. The sudden disconnect of the hose can be intentional or may be due to a break, but the result is the same: the air exits forcefully causing the hose to fling around with great force possibly causing injuries to people or damage to objects in their vicinity.

Check valves can be used to prevent such sudden decompression but such valves are designed to prevent 100% of the back flow. This property presents a problem: typically when a compressed air hose is disconnected, it is usually rolled to be stored away in a compact form. If the compressed air in the hose is not evacuated, the hose cannot be rolled away. Ideally what is needed is a leaky check valve.

U.S. Pat. No. 2,940,470 by Morgan relates to check valves of the type which open only under pressure from one direction but once opened will remain open to permit flow in the opposite direction until the opening pressure drops to a determined minimum. This check valve is not designed to bleed off compressed air.

U.S. Pat. No. 4,060,219 by Crawford describes a quick disconnect system for insertion in compressed air system wherein means are provided to hold an associated male plug in a manned such that the plug is securely held and, if an attempt is made to withdraw the plug by pulling the plug out, the hold upon the plug tends to tighten by wedging a steel ball into a smaller and smaller area. This invention is not designed to gradually bleed off the compressed air.

U.S. Pat. No. 4,418,716 by Starke is a two way flow valve in which a fluid from an input port is directed to flow along two paths to a common outlet port. This two-way valve is not designed to gradually bleed compressed air.

U.S. Pat. No. 5,290,009 by Heilmann describes a self-venting rapid connection-release coupling for compressed gas lines, in which the pressure from the compressed air locks the coupling and prevents its release unless the compressed air is vented. This invention does not operate to allow the slow release of the air pressure after the coupling is disconnected.

None of the prior art offers the functionality, safety features, simplicity and economy of use of this invention. Further features, aspects, and advantages of the present invention over the prior art will be more fully understood when considered with respect to the following detailed description claims and accompanying drawings.

### BRIEF DESCRIPTION OF THE DRAWINGS

FIG. 1 is an exploded and cross-section view of the invention. It comprises the connector threaded on the outside at one end and threaded on the inside at the other end. It also comprises the insert holding a ball.

FIG. 2 shows the insert without the ball.

FIG. 2A illustrates the insert with a ball inside.

FIG. 3 is a cross section view of the invention showing the ball in a position allowing the check valve to be fully open.

FIG. 3A is a cross section view of the invention showing the ball in a position allowing the check valve to be closed except for the permitted and intended leaks.

FIG. 4 is an exploded and cross-section view of a variation of the invention. Compared to FIG. 1, the male and female threads are reversed allowing the check valve to operate in the inverse direction.

FIG. 5 is a cross section view of the variation shown in FIG. 4 showing operation in the inverse direction. It shows the ball in a position allowing the check valve to be fully open.

FIG. 5A is a cross section view of the variation shown in FIG. 4 showing operation in the inverse direction. It shows the ball in a position allowing the check valve to be closed except for the permitted and intended leaks.

FIG. 6 illustrates how the insert can be designed without any detent mechanism to hold it in place. Instead the insert is held in place by a male plug screwed into the female end of the connector.

FIG. 7 is a cross section view of the variation shown in FIG. 6 with the insert without any detent. It shows the ball in a position allowing the check valve to be fully open with the inlet on the female end of the connector.

FIG. 7A is a cross section view of the variation shown in FIG. 6 with the insert without any detent. It shows the ball in a position allowing the check valve to be fully open with the inlet on the male end of the connector.

FIG. 8 is a detailed view of the insert variation without a detent.

FIG. 9 provides a detailed view of the insert in which the split ring is divided into three segments.

FIG. 9A shows a detailed view of the insert with the split ring divided in three segments and having no detent mechanism.

FIG. 10 illustrates how an off-the-shelf connector traversed by a metal bar can be adapted to perform as a leaky check valve.

FIG. 10 A provides an end view of the off-the-shelf connector of FIG. 10.

### SUMMARY OF THE INVENTION

The check valve described in this invention prevents the sudden decompression of air contained in a compressed air hose while allowing the air to exit at a safe and slow rate. Essentially, this invention is a leaky check valve. It comprises:
a) a hollow cylindrical connector typically equipped at either end with a means for coupling it to compressed air plugs, tools, hoses, etc.
b) an annular valve seat in the shape of a truncated cone, oriented such that the truncated apex of the cone faces the inlet, and the inner surface of the cone faces the outlet. The inner surface of the valve seat is indented with at least one radial groove to allow air to slowly leak out when it flows in the reverse direction.
c) a ball positioned within the cylindrical space, between the seat and the outlet; and
d) a ball restraint located within the cylindrical space between the ball and the outlet to prevent the ball from obstructing the outlet when air is flowing in the forward direction.

When the fluid flow is in the forward direction, that is, from the inlet to the outlet, the ball is pushed against the ball restraint and the fluid flow is essentially not obstructed by the ball. When the fluid flow is in the reverse direction, that is, from the outlet to the inlet, the ball is pushed against the annular valve seat. The fluid flow is partially obstructed by the ball: the grooves in the seat allow slow leakage of the fluid.

Variations to this basic theme include the implementation of the valve seat and ball restraint typically made of plastic, by means of an insert that fits inside the cylindrical connector. This insert comprises:
a) The valve seat coaxial with the cylindrical connector, and located on the inlet side of the connector.
b) The ball restraint shaped as a ring, co-axial with the annular seat and located on the outlet side of the connector. The ring is split in segments.
c) A multiplicity of axially oriented bars, connecting each segment of the restraining split ring to the annular valve seat.

The valve seat, bars, and segmented ring essentially form a cylindrical cage enclosure which holds the ball.

To hold the insert in place within the connector, a detent mechanism can be used. For example, the split ring can be shaped on its periphery with a protuberance, matching in shape a groove located on the internal surface of the cylindrical connector. The bars linking the seat to the split ring segments can be made flexible enough to allow them to bend when the insert is pushed inside the connector. Flexible bars can also be useful to allow the ball to be placed into the insert.

The cylindrical connector can be made with various couplings on its inlet and outlet ends. For example the inlet can be threaded as a male and the outlet as a female or vice versa. In addition both inlet and outlet can be threaded as males or both can be threaded as females.

The detent mechanism on the insert may be eliminated by relying on the coupling to perform the retention of the insert. For example, a male plug screwed into a female port of the connector can hold the insert in place.

The split ring can be divided into a number of segments, for example three or four segments. In addition, the number of groves on the annular valve seat can vary. For example there may be three grooves or four grooves or any convenient number of grooves. The depth of the grooves will determine the rate of back flow of the air. Grooves ranging from 0.005 inches to 0.01 inches in depth are most convenient. However, it is possible to have grooves ranging from 0.001 inches to 0.04 inches in depth. It all depends on the desired rate of backflow.

An off the shelf compressed air connector can be adapted to operate as a leaky check valve: grooves can be chiseled on the inside of the connector to provide a means for the compressed air to leak out, and ball restraint can be formed by obstructing the outlet with a bar traversing the connector near the outlet side.

### DETAILED DESCRIPTION

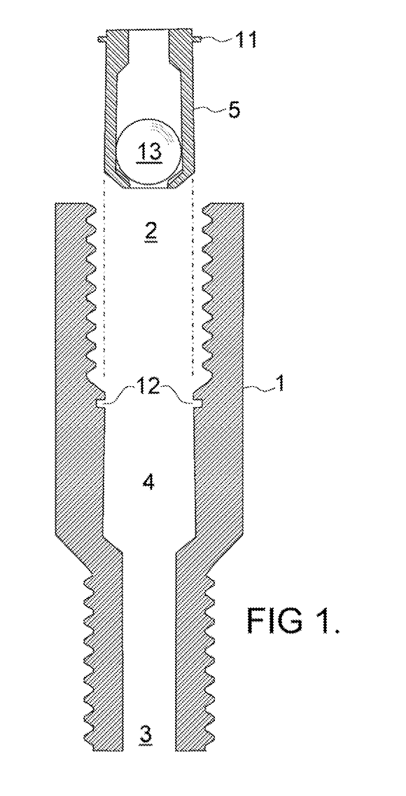

This invention is illustrated in the cross-sections diagrams shown in FIG. 1. The device is essentially a leaky check valve and comprises three parts. The first part is a bisexual threaded connector 1 typically made of metal such as brass. One end of the connector is internally threaded to form a female end 2 and the other side is externally threaded to provide the male end 3.

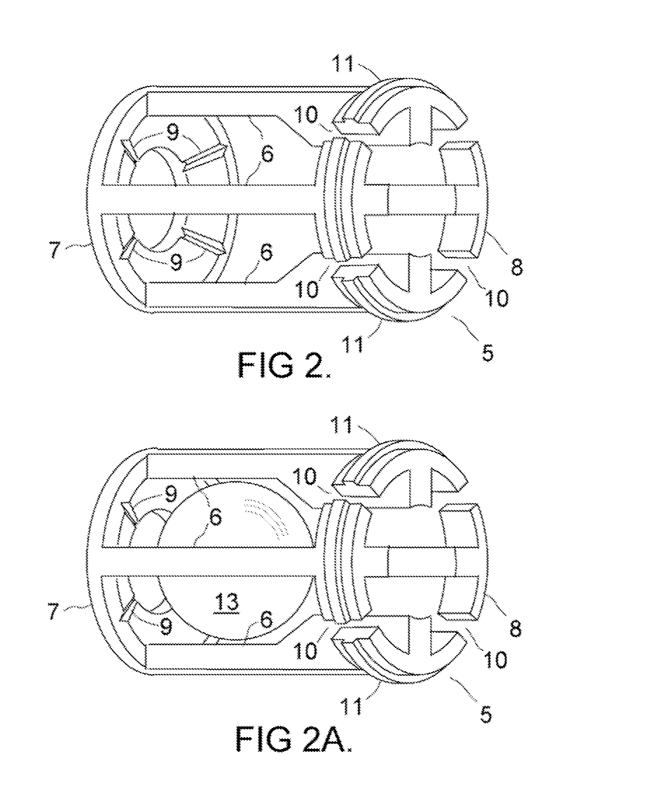

The central area of the connector 1 consists of a cylindrical space 4 into which fits the second part of the invention, an insert 5, typically made of plastic and shown in detail in FIG. 2. This insert 5 is approximately in the shape of a cylindrical cage comprising a number of bars 6 on the periphery of the cylinder and parallel to its axis, which connect an annular and conical seat 7 to a split ring 8. The seat is indented by grooves 9 approximately 0.005 inches to 0.01 inch deep. The split ring 8 is opened at several locations 10 around its periphery. The split ring 8 includes on its periphery a detent 11 mechanism in the shape of a circular protuberance that fits into a circular groove 12 on the inside of the connector 1. This detent 11 allows the insert 5 to remain firmly anchored inside the connector 1. During assembly of the device, the bars 6 of the insert are flexible enough to allow the insert to be pushed inside the connector 1 and the detent 11 to open up when it reaches the circular groove 12 in the connector, thereby locking the insert 5 in place.

The third part of the invention is a ball 13 made of plastic or metal that fits inside the cage formed by the insert 5 as shown in FIG. 2A. The bars 6 of the insert 5 are flexible enough to allow the insertion of the ball 13 inside the cage before the insert 5 is pushed inside the connector 1 as described in the previous paragraph.

The connector can be of a strong material such as metal, for example brass. The insert and the ball can be made of metal or plastic.

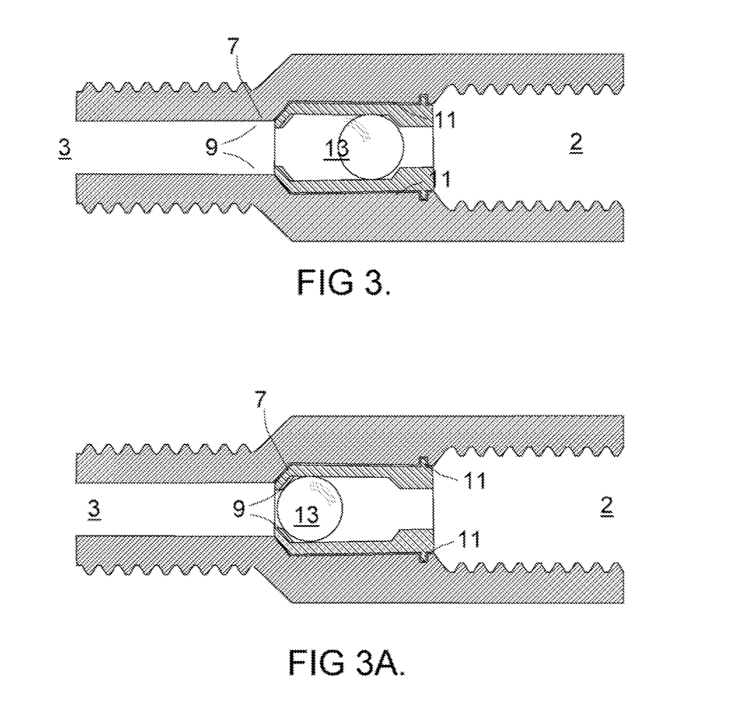

When the device operates as an open check valve as shown in FIG. 3, air enters the insert 5 through the annular/conical seat 7. The air pressure pushes the ball toward the split ring 8. The air is not impeded by the ball 13; it flows around it and exits through the split ring 8.

In closed check valve operation shown in FIG. 3A the device operates as a leaky check valve. Air pressure pushes the ball 13 against the annular/conical seat 7. The grooves 9 formed in this seat 7 prevent the ball 13 from completely stopping air flow thereby allowing the compressed air to slowly leak out through the grooves 9.

This leaky check valve device can be attached between a hose and a conventional compressed air plug to prevent a violent discharge of the compressed air when the air plug is suddenly disconnected. After the compressed air has bled off, the hose can be conveniently rolled and stored away.

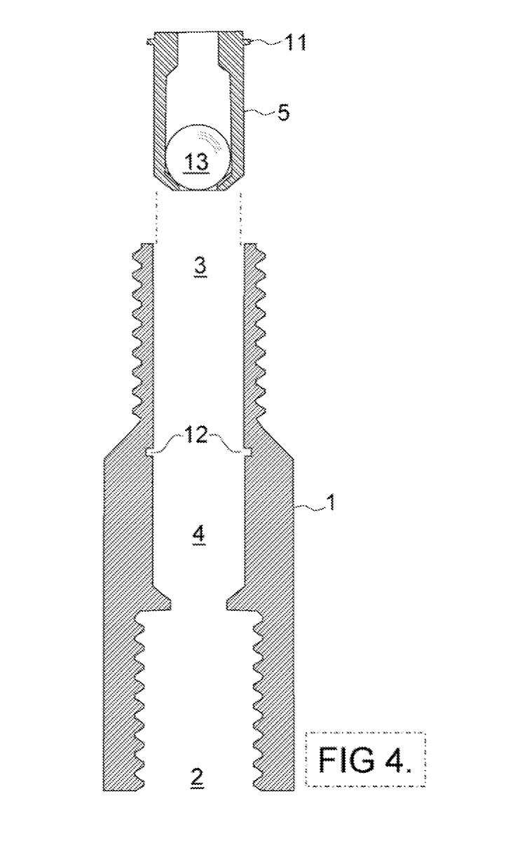

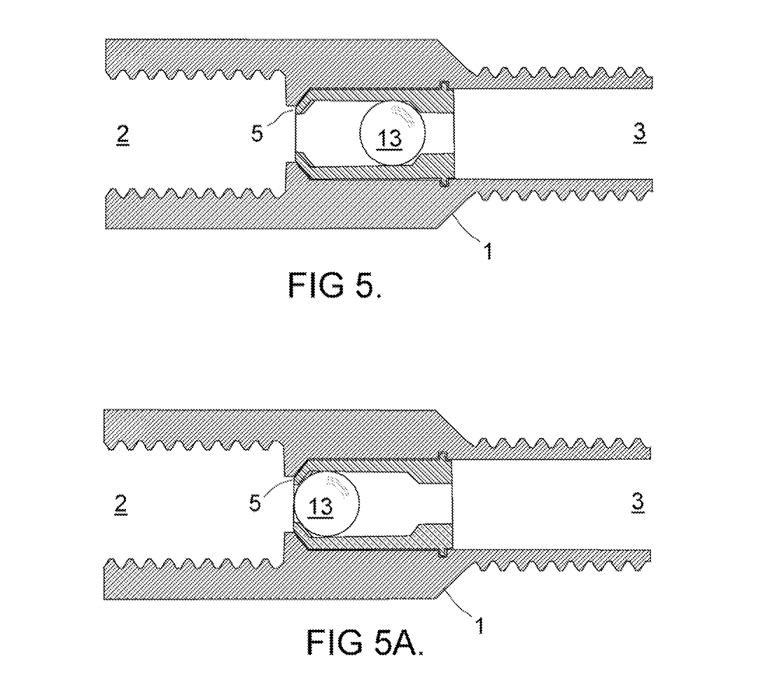

As is evident to a person having ordinary skills in the art, a number of variations are evident some of which are listed below. The male end 3 and the female end 2 of the connector can be reversed as shown in FIG. 4, FIG. 5 and FIG. 5A, thereby allowing the device to operate in the inverse direction.

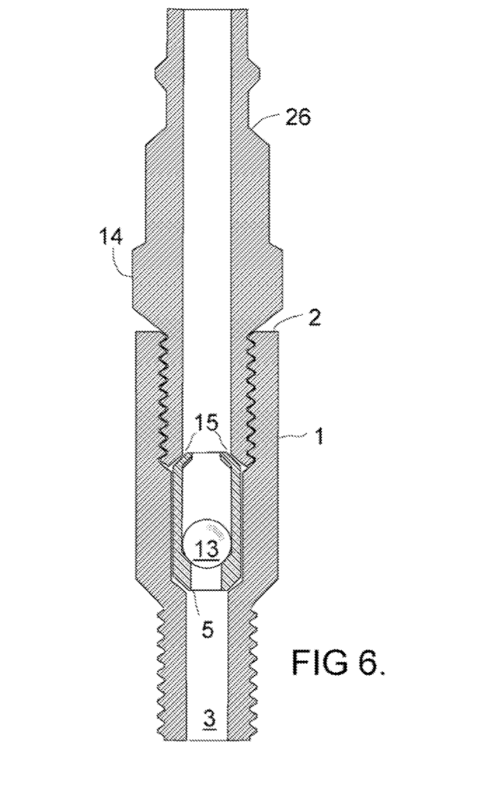

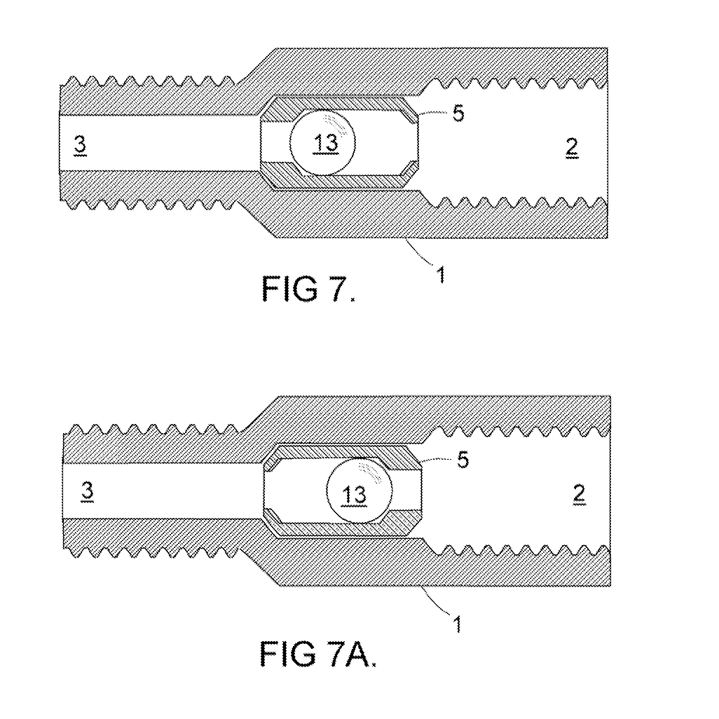

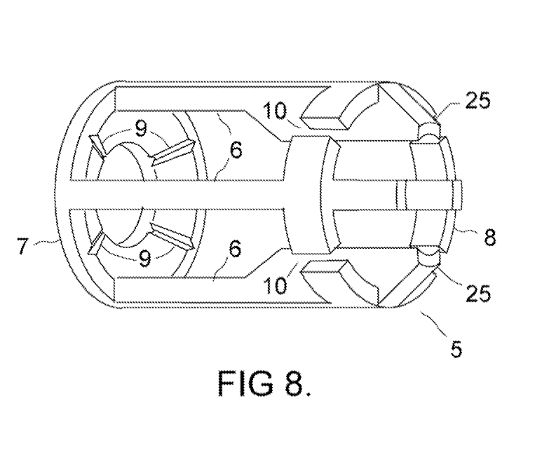

FIG. 6, FIG. 7, FIG. 7A and FIG. 8 illustrate yet another variation according to which no detent mechanism is necessary. In this case, the insert 5 is loosely kept in place by the male plug 14 which screws inside the female end 2 of the connector 1. To ensure a tight and leakage-free fit for the male plug 14, it is important for the insert 5 to provide enough clearance 15 for the male plug 14 to be fully screwed in. FIG. 6 depicts how the insert 5 fits inside the female side 2 of the connector 1 and is held in place by the male plug 14. FIG. 7 shows how the insert 5 is inserted to allow free air flow from the female end 2 to the male end 3 of the connector 1. FIG. 7 A shows the opposite configuration in which air can flow freely from the male end 3 to the female end 2. FIG. 8 provides a detailed description of the insert 5.

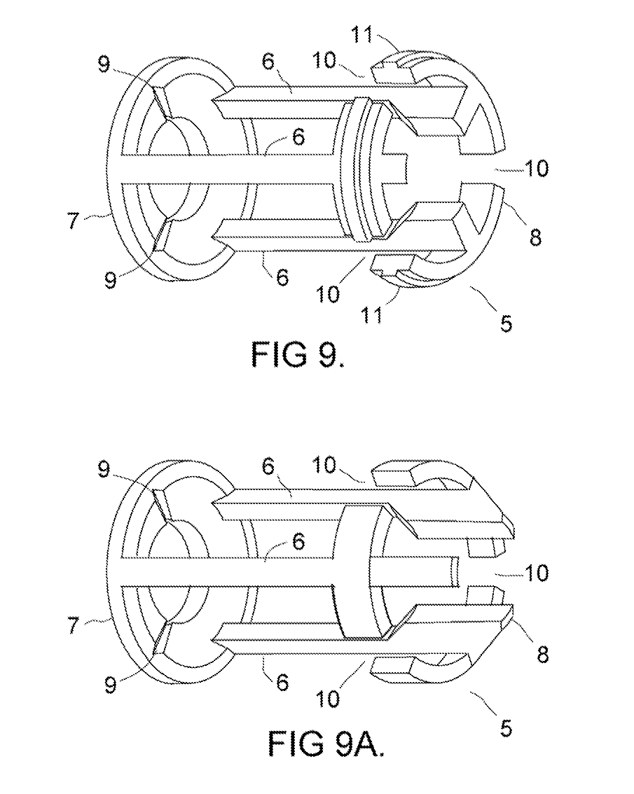

FIG. 9 and FIG. 9A show inserts with three bars 6 instead of four bars. FIG. 9 includes a detent mechanism 11 on the periphery of the split ring 8 and FIG. 9A doesn't have any detent mechanism but includes extensions 25 of the bars 6 beyond the split ring 8. These extensions are used to keep the insert 5 snuggly in place, restrained by the male plug 26 shown in FIG. 6.

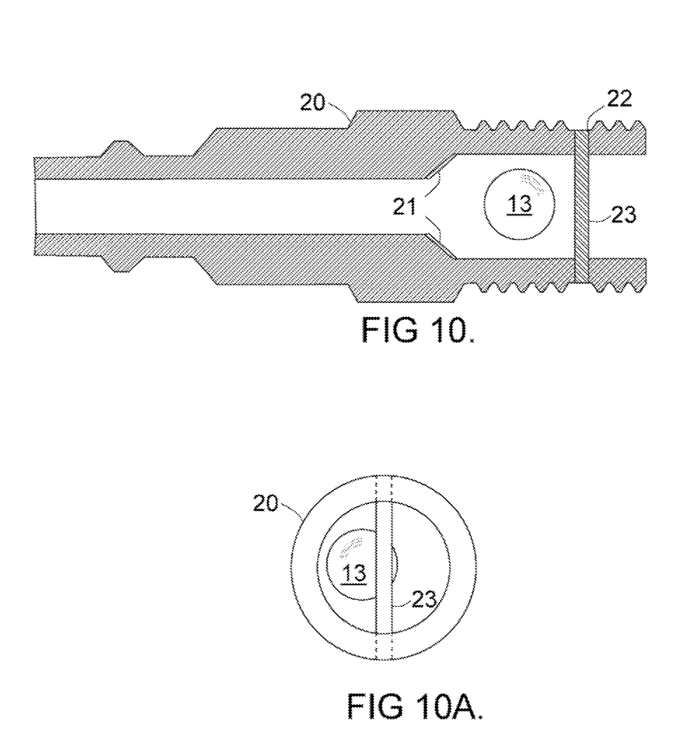

FIG. 10 illustrates a variation in which a conventional off-the-shelf connector 20 is adapted to perform as a leaky valve. The function of slow leak (performed by the leaky valve seat in the previous examples) is provided by indentations 21 formed inside the body of the connector 20 itself. These indentations 21 may be implemented by chiseling the metal on the inside surface of the connector 20 with a sharp tool. The function of retaining the ball and allowing air to pass (performed by the split ring in the previous examples), is provided by a bar traversing the connector. Essentially a hole 22 is drilled into the connector and a bar 23 is inserted through the hole 22. A ball 13 inserted inside the connector 20 is kept in place by the bar. FIG. 10A provides an end view of the connector showing the ball 13 restrained behind the bar 23. Thus an off-the-shelf connector adapted as described above can perform as a leaky valve.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

I claim:

1. A leaky ball check valve for compressed fluid, allowing said fluid to flow in a first direction, said first direction called forward direction, and partially obstructing flow of said fluid in the opposite direction, said opposite direction called reverse direction, said leaky check valve comprised of;
a) a hollow cylindrical connector having two ends, the first end being called the inlet and the second end being called the outlet, said inlet and said outlet each having a compressed fluid coupling mechanism, said cylindrical connector shaped to have in its interior essentially a co-axial cylindrical space, and furthermore said cylindrical connector defining an axial direction;
b) an annular seat in the shape of a truncated cone, said seat coaxial with said cylindrical connector, and oriented such that its truncated apex faces said inlet, and its internal surface faces said outlet and furthermore, said seat indented in its said interior surface with at least one radial groove;
c) a ball positioned within said cylindrical space, between said seat and said outlet; and
d) a ball restraint located within said cylindrical space between said ball and said outlet,
whereby, when said fluid flows from said inlet to said outlet, said ball is forced against said ball restraint and flow of said fluid is essentially not obstructed by said ball,
and furthermore, when said fluid flows from said outlet to said inlet, said ball is forced against said annular seat and flow of said fluid is allowed to seep through said grooves.

2. A leaky ball check valve as in claim 1 wherein said annular seat and said ball restraint are parts of an insert, said insert essentially cylindrical in shape and fitting into said cylindrical space, said insert comprising:
a) said seat coaxial with said cylindrical connector,
b) a multiplicity of bars, the first end of each attached to the periphery of said seat and projecting in said axial direction toward said outlet; and
c) said ball restraint shaped as a ring, co-axial with said annular seat, said ring split in segments, each said segment supported by, and attached to, one of the second ends of said bars; and
d) said seat, bars, and segmented ring essentially forming a cylindrical cage enclosure; and
said ball placed within said cage enclosure.

3. A leaky check valve as in claim 2 equipped with a detent mechanism for locking in place said insert, wherein said split ring is shaped on its periphery with a protuberance, and said cylindrical connector is equipped on its internal surface with a groove matching said protuberance, said bars being flexible to allow the insertion and the locking in place of said insert into said cylindrical connector.

4. A leaky check valve as in claim 2 wherein said bars are flexible to allow the insertion of said ball.

5. A leaky check valve as in claim 2 wherein said inlet is threaded on the inside surface of said cylindrical connector thereby forming a female port.

6. A leaky check valve as in claim 5 wherein said insert is held in place inside said cylindrical connector by the presence of a male plug screwed into said female port.

7. A leaky check valve as in claim 2 wherein said outlet is threaded on the outside surface of said cylindrical connector thereby forming a male port.

8. A leaky check valve as in claim 2 wherein said inlet is threaded on the outside surface of said cylindrical connector thereby forming a male port.

9. A leaky check valve as in claim 2 wherein said outlet is threaded on the inside surface of said cylindrical connector thereby forming a female port.

10. A leaky check valve as in claim 9 wherein said insert is held in place inside said cylindrical connector by the presence of a male plug screwed into said female port.

11. A leaky check valve as in claim 2 wherein said split ring is divided into three said segments.

12. A leaky check valve as in claim 2 wherein said split ring is divided into four said segments.

13. A leaky check valve as in claim 1 wherein said ball restraint is a bar traversing said cylindrical connector, perpendicular to said axial direction.

14. A leaky check valve as in claim 1 wherein said annular seat comprises three grooves.

15. A leaky check valve as in claim 1 wherein said annular seat comprises four grooves.

16. A leaky check valve as in claim 1 wherein said grooves range from 0.005 inches to 0.01 inches in depth.

17. A leaky check valve as in claim 1 wherein said grooves range from 0.001 inches to 0.04 inches in depth.

18. A leaky check valve for compressed fluid, allowing said fluid to flow in a first direction, said first direction called forward direction, and partially obstructing flow of said fluid in the opposite direction, said opposite direction called reverse direction, said leaky check valve comprised of:
a) a hollow cylindrical connector having two ends, the first end being called the inlet and the second end being called the outlet, said inlet and said outlet each having a compressed fluid coupling mechanism, said cylindrical connector shaped to have in its interior a co-axial cylindrical space;
b) an insert essentially cylindrical in shape, fitting into said cylindrical space, said insert comprising:
i) an annular seat in the shape of a truncated cone, said seat coaxial with said cylindrical connector, and oriented such that its truncated apex faces said inlet, and its internal surface faces said outlet, and furthermore, said seat indented in its said interior surface with at least one radial groove;
ii) a multiplicity of bars the first end of each attached to the periphery of said seat and projecting in the axial direction toward said outlet, and
iii) a ring, co-axial with said annular seat, said ring split in segments, each said segment supported by, and attached to, one of the second ends of said bars,
iv) said seat, bars, and segmented ring essentially forming a cylindrical cage enclosure; and
c) a ball placed within said cage enclosure,
whereby, when said fluid flows from said inlet to said outlet, said ball is forced against said segmented ring and said fluid is allowed to seep through said grooves.
and furthermore, when said fluid flows from said outlet to said inlet, said ball is forced against said annular seat and flow of said fluid is allowed to seep through said grooves.
